(19) United States
(12) Patent Application Publication
(10) Pub. No.: US 2008/0172666 A1
(43) Pub. Date: Jul. 17, 2008

(54) VIRTUAL COMPUTER SYSTEM AND SCHEDULING METHOD THEREOF

(76) Inventor: Hironori Inoue, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/972,891

(22) Filed: Jan. 11, 2008

(30) Foreign Application Priority Data
Jan. 15, 2007 (JP) 2007-005350

(51) Int. Cl. G06F 9/455

(52) U.S. Cl. 718/1

(57) ABSTRACT

Each virtual computer is arranged to have an exclusive-use timer mechanism in a physical computer in the form of a virtual timer with a physical timer as a timer source. Upon execution of virtual computer scheduling processing, a hypervisor uses information, such as “virtual timer value” or “accumulation of processor usage times” of each virtual computer, to perform dispatching while determining a virtual computer to be dispatched by priority and computing its dispatch time. With this approach, a scheduling method capable of simultaneously satisfying “(1) least possible interruption delay,” “(2) uniformization of accumulation of processor use times of each virtual computer” and “(3) effective use of processor idle time” is provided. In particular, regarding the requirement (1), the function of causing a report to virtual computer upon at the time of timer interruption to become zero in delay is realized.

The present application claims priority from Japanese application JP2007-005350 filed on Jan. 15, 2007, the content of which is hereby incorporated by reference into this application.

### BACKGROUND OF THE INVENTION

The present invention relates generally to virtual computer systems, and more particularly to a technique effectively adaptable for use with a scheduling method of realizing high-accuracy timer interruption in a virtual computer system having a physical computer which is logically divided into more than two virtual computers for practical use.

Currently known scheduling methods for a virtual computer system include a time slicing technique. This time slice technique is a scheme for dividing the operation time of a command processor of a physical computer into time segments or slots, called the time slices. A processing ability is predefined on a per virtual computer basis. In accordance with such definition, the allocation of a processor of the physical computer is performed with respect to each virtual computer in units of time slices. With this arrangement, it is possible to use, at more than two virtual computers, the processing ability of the physical computer in a time division or time sharing manner.

An example of the virtual computer scheduling method employing this type of time slice technique is disclosed, for example, in JP-A-2003-177928. The scheduling method as taught thereby is the one that sets a time-slicing time period at a variable value to thereby prevent occurrence of a deviation or “bias” of a schedule pattern. In other words, this is a technique which makes the one-time assigned time slice period variable in value by a service rate of virtual computer, for performing the scheduling in such a way that the number of scheduling events within a prespecified length of time period—these have been different in a way depending on the service rate—becomes the same.

Another known scheduling method is disclosed, for example, in JP-A-2005-18560, which method causes a hypervisor to determine a target virtual computer for allocation of a processor while at the same time computing adequate performance and time for such processor allocation. Each virtual computer is designed to have a priority setting unit and a monitoring unit. The hypervisor is operatively responsive to receipt of a priority change notice, such as “accumulation of processor allocation times of each virtual computer” and/or “excess or deficiency of processor resources of previous unit time,” for performing adequate allocation of the processor resources.

### SUMMARY OF THE INVENTION

Unfortunately, the prior known time-slice scheduling method as disclosed in the above-identified JP-A-2003-177928 is faced with a problem which follows. Upon occurrence of an interruption against a virtual computer, a delay of interruption processing takes place, resulting in a likewise decrease in processing ability of the virtual computer. This can be said because it is unable to accept the interruption until the virtual computer which is expected to receive such interruption becomes capable of using the physical computer's command processor.

To solve this problem, the above-noted JP-A-2005-18560 suggests a technique for changing the processor resources (in particular, the allocation time) in a way pursuant to a change in priority of each virtual computer to thereby reduce or prevent the delay of the interruption processing. Use of this technique makes it possible to achieve a processor allocation scheduling method capable of stably handling and managing the system at low costs.

However, this prior art fails to teach nor suggest in any way a method of zeroing the delay of a report to such virtual computer in terms of a specific kind of interruption processing wherein a time point at which the hypervisor generates an interruption, such as a timer interruption among several interruption events, is known in advance.

It is therefore an object of this invention to provide a scheduling method capable of simultaneously satisfying three principal requirements as to the scheduling processing at virtual computers, i.e., “(1) the least possible interruption delay,” “(2) uniformization of an accumulation of the processor use time durations of each virtual computer,” and “(3) effective use of processor idle time.” In particular, regarding the requirement (1), it is an object to realize the functionality for enabling the delay of a report to a virtual computer at the time of a timer interruption event to become zero.

These and other objects, features and advantages of the invention will become apparent from the following more particular description of a preferred embodiment of the invention, as illustrated in the accompanying drawings.

A description of brief summary of a representative one of principal concepts of the invention as disclosed herein will be given below.

To attain the foregoing object, the invention has the following features unique thereto. Virtual computers are each arranged to have, for exclusive use therein, a timer mechanism in a physical computer in the form of a virtual timer with a physical timer being as a timer source. A hypervisor (using a processor allocation algorithm) is the one that utilizes during execution of the scheduling processing to a virtual computer(s) the information, such as “virtual timer value” and/or “processor usage time accumulation” of each virtual computer, to perform the dispatching by specifying a virtual computer to be dispatched (i.e., subjected to processor allocation) on a priority basis while at the same time computing a dispatch time thereof.

A brief explanation of effects obtainable by the representative one of the core concepts of the invention as disclosed herein is as follows.

According to this invention, by taking into consideration the “virtual timer value” in the scheduling processing of the hypervisor, it becomes possible to attain the basic requirement item (1) stated above. Taking into account the “processor use time accumulation” makes it possible to achieve the basic requirement (2). Furthermore, by taking into consideration the feature which excludes a process in the rest state from the candidates for dispatch targets, it is possible to satisfy the basic requirement (3). By realization of these three functions, it becomes possible to efficiently handle and manage the processor's resources, which in turn makes it possible to improve the processing performance of virtual computers.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an exemplary arrangement of a virtual computer system in accordance with one preferred embodiment of the present invention.

FIG. 2 is a diagram showing an exemplary program operation in a guest OS running on each of two virtual computers in the virtual computer system of the embodiment of this invention.

FIG. 3 is a diagram showing a detailed example of a control operation within a hypervisor in the virtual computer system embodying the invention.

FIG. 4 is a diagram showing a configuration example of a scheduling control table in the virtual computer system embodying the invention.

FIG. 5 is a flow diagram showing a control operation example (algorithm for determining a virtual computer to be subjected to dispatching by priority and its dispatch time) of scheduling processing in the virtual computer system embodying the invention.

### DETAILED DESCRIPTION OF THE INVENTION

A currently preferred form of this invention will be described in detail with reference to the figures of the drawing below. Note that in all of the accompanying drawings for explanation of one embodiment of the invention, the same parts or components are indicated in principle by the same reference numerals, and a repetitive explanation thereof will be eliminated.

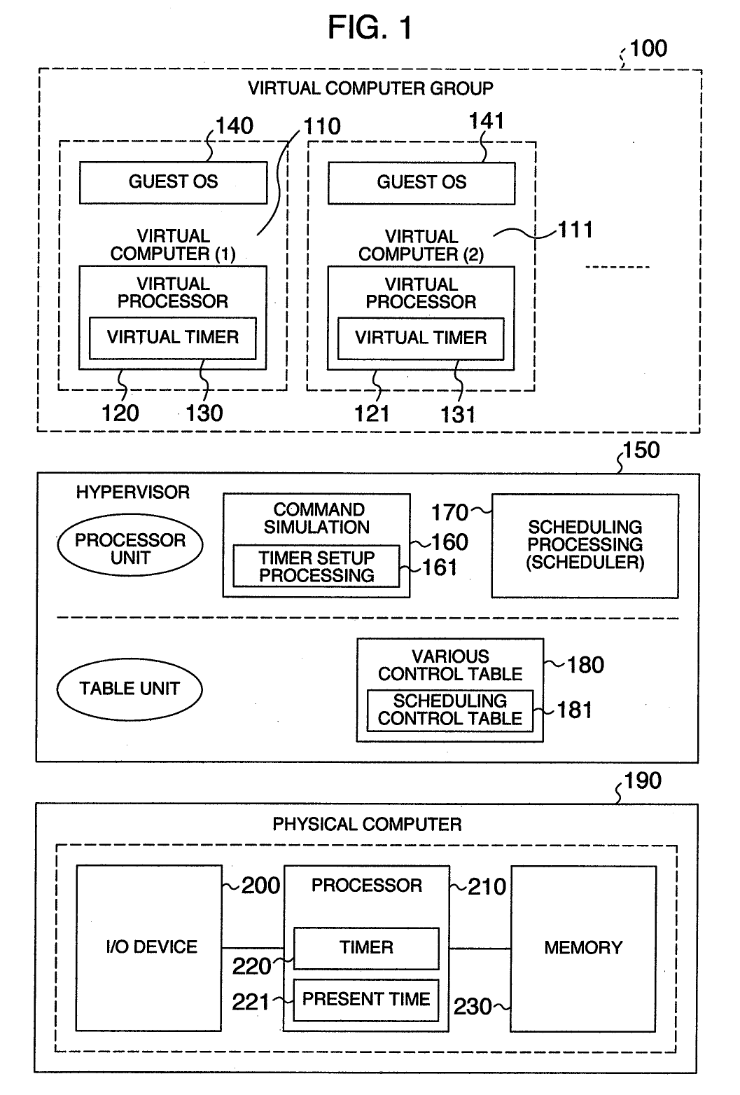

FIG. 1 is a diagram showing an exemplary configuration of a virtual computer system in accordance with one embodiment of this invention. In the virtual computer system of this embodiment, a physical computer 190 has an input/output (I/O) device 200, a processor 210, and a memory 230. The processor 210 internally has a timer 220, and stores therein data indicative of a present time point 221.

A hypervisor 150 is a software program which runs on the physical computer 190. The hypervisor 150 has its function of logically dividing the resource of a physical computer, such as the processor 210, to thereby establish a plurality of virtual computers 110, 111, . . . , and a function of performing management and control thereof. These virtual computers 110, 111, . . . are for arranging a virtual computer group 100.

Virtual processors 120, 121, . . . within the virtual computers 110, 111, . . . have virtual timers 130, 131, . . . , respectively, which are the same in specifications as the timer 220 in the processor 210 of physical computer 190. A respective one of these virtual timers 130, 131, . . . is a logical timer of the type using the timer 220 of physical computer 190 as a timer source.

With these functions, it is possible to permit guest operating systems (OSs) 140, 141, . . . to run on the virtual computers 110, 111, . . . , respectively.

Logical division of the processor 210 is realized by allocating the processor 210 to each virtual computer 110, 111, . . . once per fixed length of time period (time slice value). With this time-division scheme of the processor 210, the hypervisor 150 executes time-slice scheduling for each virtual computer 110, 111, . . . on one occasion and generates an interruption from the physical computer 190 to each virtual computer 110, 111, . . . on another occasion. This processing is actualized by a timer setup processing 161 within command simulation 160, a scheduling processing 170, and a scheduling control table 181 in a various-kind control table 180, which table becomes the information source when performing the scheduling processing.

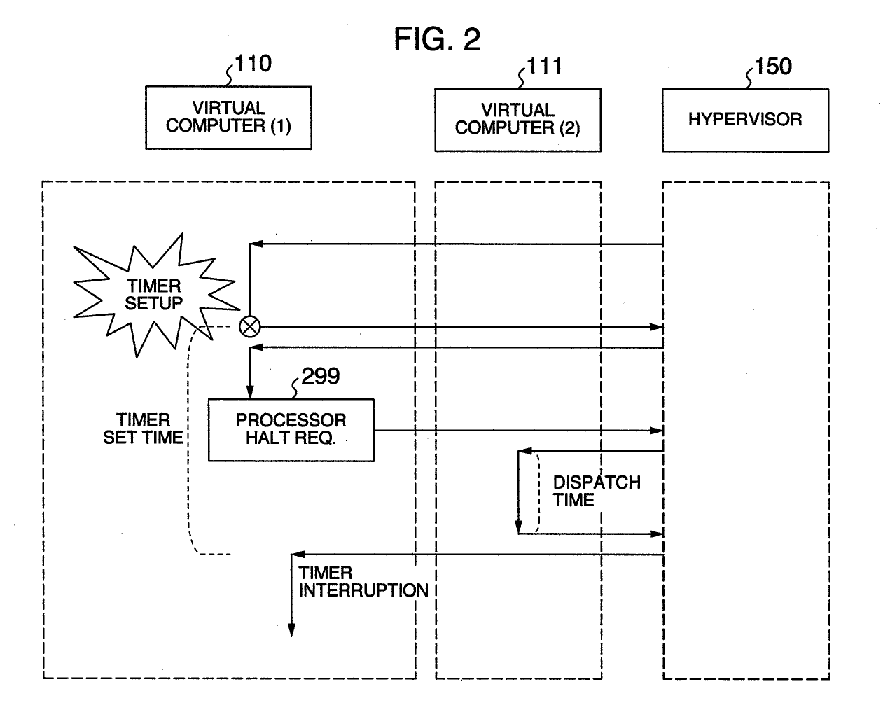

FIG. 2 is a diagram showing a program operation example in the guest OSs running on two separate virtual computers (1) 110 and (2) 111, respectively, in the virtual computer system of this embodiment.

When a timer is set by the program running on the virtual computer (1) 110, the virtual computer (1) 110 passes its control to the hypervisor 150. Here, the hypervisor 150 stores therein such the timer value and then returns the control to the virtual computer (1) 110.

Suppose that after the control was returned to the virtual computer (1) 110, a processor halt or pause request 299 is called up. Although this processor halt request 299 becomes an intervention to the hypervisor 150, the hypervisor 150 does not regard the process in the halt state as a dispatching target. One typical reason of this is for enhancement of the efficiency. In other words, in this case, the hypervisor 150 dispatches the virtual computer (2) 111.

In doing so, the hypervisor 150 calculates for allocation a length of time as taken to dispatch the virtual computer (2) 111 from the value of a virtual timer which has been stored in the timer setup event or the like, thereby to ensure that no delay takes place of a report of the timer interruption toward the virtual computer (1) 110. When the virtual computer (2) 111 has used up this dispatch time, the control is again returned to the hypervisor 150. In responding thereto, the hypervisor 150 activates or “triggers” timer interruption to the virtual computer (1) 110. In this event, the interruption occurs accurately at the timer's setup time point owing to adjustment of the dispatch time to the virtual computer (2) 111. Thus, there is no risk as to unwanted occurrence of a timer interruption report delay.

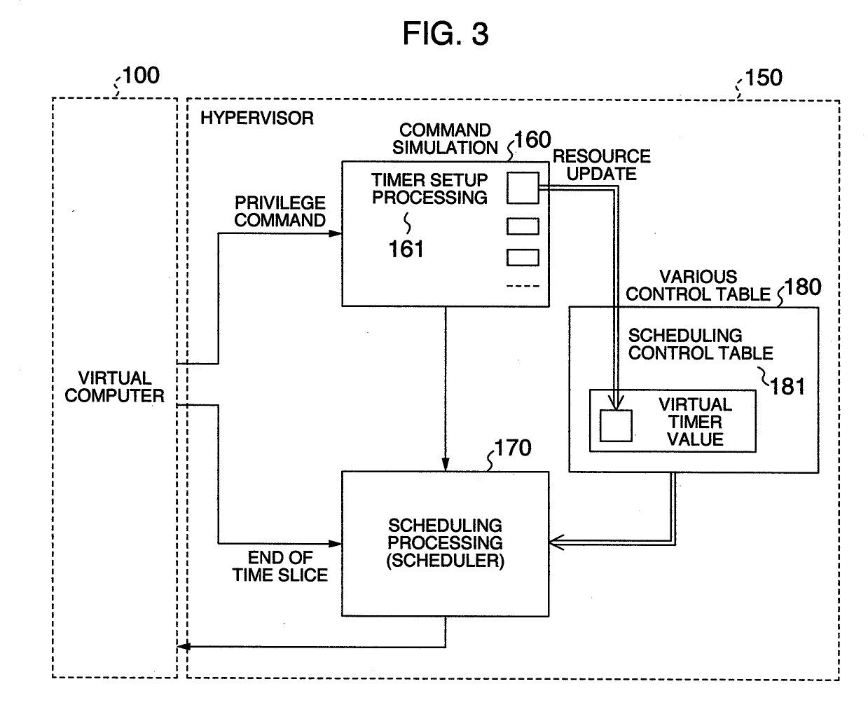

FIG. 3 is a diagram showing in detail an example of a control operation which is internally executed in the hypervisor 150. There are two event nodes or “chances” for turning back to the hypervisor 150 from the processing of the virtual computers 110, 111, . . . of the virtual computer group 100. One is a time point whereat a command (privilege instruction) for control of an entirety of the system is issued; the other is when the time-splicing period which was given to virtual computer 110, 111, . . . is expired.

In the case of the former, necessary simulation is performed at the command simulation 160, thereby passing the control to the scheduling processing 170 of the hypervisor 150. In the latter case, the control is directly passed to the scheduling processing 170 of the hypervisor 150; thus, the scheduling processing is executed without change. The scheduling processing 170 of the hypervisor 150 is such that upon receipt of the control, the scheduling control table 181 within the various-kind control table 180 is used to determine a virtual computer to be next dispatched and also quickly compute its dispatch time, followed by execution of the dispatching of such the virtual computer.

While the procedure stated above is a fundamental operation until the next virtual computer for example, the virtual computer (2) 111 is dispatched after the control was returned to the hypervisor 150 from a given virtual computer, e.g., the virtual computer (1) 110, a processing task of updating the virtual timer value is added to the above operation in cases where the timer setup processing 161 takes place in the command simulation 160. When the timer setup processing 161 is activated in the command simulation 160, the hypervisor 150 first updates the virtual timer value of such virtual computer within the scheduling control table 181 and then passes the control to the scheduling processing 170. Upon receipt of the control, the scheduling processing 170 of the hypervisor 150 computes a virtual computer to be next dispatched and its dispatch time based on the information of the scheduling control table 181, including the updated virtual timer value, and then performs dispatching to the virtual computer thus designated.

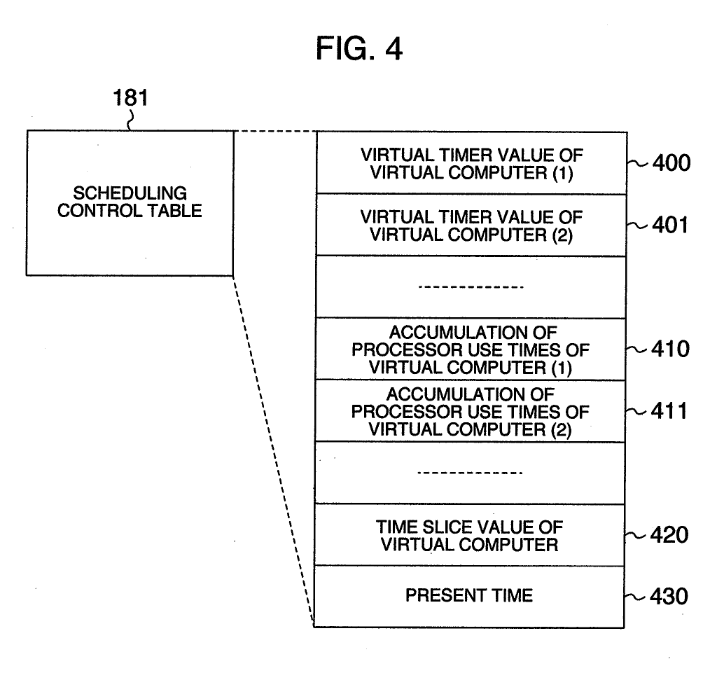

FIG. 4 is a diagram showing a configuration example of the scheduling control table 181. The scheduling processing 170 of the hypervisor 150 is performed based on this scheduling control table 181. In the scheduling control table 181, there are stored a virtual timer value 400, 401, . . . which is a time point whereat the next timer interruption occurs at each virtual computer 110, 111, . . . , an accumulation 410, 411, . . . of processor usage times of each virtual computer, a time slice period value 420 of virtual computer, and a present time point 430 which was acquired from the present time 221 within the physical processor 190.

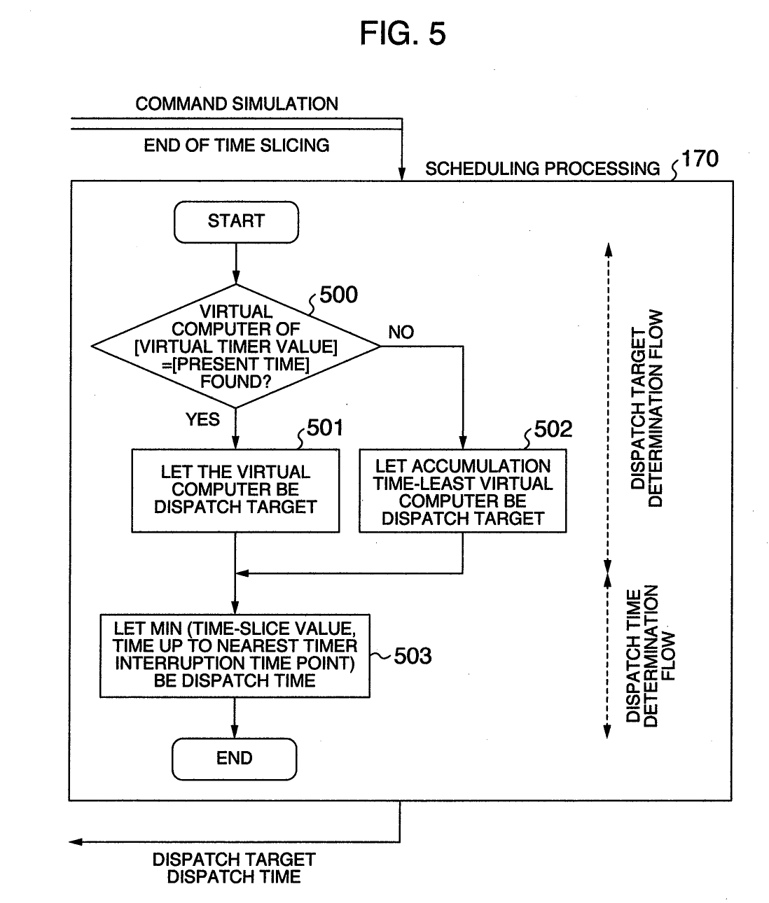

FIG. 5 is a flowchart showing one example of the algorithm for allowing the scheduling processing 170 of the hypervisor 150 to utilize the scheduling control table 181 to determine a virtual computer to be dispatched by priority and a dispatch time thereof. Note that this is under an assumption that the processing is forced to progress while excluding from a list of dispatch targets a dispatch-unable virtual computer(s), such as the virtual computer that is under the calling of the halt state of the processor in the example of FIG. 2.

The processing flow is diverged into two sub-routines, one of which is for dispatch target determination (at steps 500, 501 and 502), and the other of which is for dispatch time determination (at step 503). Upon receipt of the control, the scheduling processing 170 first compares the virtual timer value 400, 401, . . . of each virtual computer in the scheduling control table 181 to the present time point 430 to thereby promptly check whether there is a virtual computer for occurrence of a timer interruption (at step 500). More specifically, checking is done to determine whether there is a virtual computer with its virtual timer value being equal to the present time, i.e., [virtual timer value]=[present time].

In a case where there is immediately found a virtual computer which generates the timer interruption (i.e., “YES” at step 500), let this virtual computer be a dispatch target (at step 501). If no such virtual computer is found (“NO” at step 500), an attempt is made to compare together the accumulations of the processor usage time lengths of respective virtual computers to specify a virtual computer with its accumulated time being the least in value and then set it as a dispatch target (at step 502). By increasing the priority of the virtual computer which is less in accumulation time, it is possible to realize uniform allocation of the processor resources to each virtual computer.

Subsequently, comparison is done between a length of time from the present time to a time point at which the timer interruption is to be next generated in the nearest feature and the time slice value 420 of the scheduling control table 181, and smaller one is set as a dispatch time (at step 503). With this operation, in case there is a virtual computer with occurrence of the timer interruption at the nearest time (within the time slice period from the present time), a dispatch time for the previous virtual computer to be dispatched becomes until immediately before the timer interruption occurrence time point. Thus, the control is returned to the hypervisor 150 prior to the timer interruption. As the hypervisor 150 instantly regards, by priority, the timer interruption-occurring virtual computer to be the target of the dispatching, the timer interruption occurs exactly at the setup time of the timer. This makes it possible to avoid unwanted occurrence of any interruption report delay.

With this technique, it is possible for the virtual computer system of this embodiment to achieve the intended scheduling capable of satisfying at a time the basic requirement items for “(1) the least possible interruption delay,” (2) the uniformization of an accumulation of the processor use times each respective virtual computer,” and “(3) the effective use of a processor idle time.” In particular, regarding the requirement (1), a delay of the timer interruption becomes zero. As for the requirement (2), a difference between the maximum and minimum values of the accumulation time is suppressible to fall within the time slice period in any events. Concerning the requirement (3), any process in a rest or halt state is excluded from the candidates for dispatch targets. Offering these features ensures that the scheduling processing relative to a virtual computer(s) is performed continuously or “seamlessly” whereby any idle time no longer takes place in the processor. Thus it becomes possible to efficiently handle and manage the processor resource, which in turn makes it expectable to improve the processing performance of the individual virtual computer.

Although the invention has been particularly shown and described with reference to a preferred embodiment thereof, it will be understood by those skilled in the art that the foregoing and other changes in form and details may be made therein without departing from the spirit and scope of the invention.

This invention is applicable to virtual computer systems of the type having a physical computer which is logically divided into a plurality of virtual computers for usage. In particular, by realizing high-accuracy timer interruption, it becomes possible to increase the practical applicability of a virtual computer system, such as for example a software program under the requirement for high accuracy and precision in terms of the time.

It should be further understood by those skilled in the art that although the foregoing description has been made on embodiments of the invention, the invention is not limited thereto and various changes and modifications may be made without departing from the spirit of the invention and the scope of the appended claims.

1. A scheduling method for allocating a processor to each virtual computer in accordance with a degree of priority in a virtual computer system with a physical computer being logically divided into a plurality of virtual computers for usage, said method comprising the steps of:
providing a virtual timer value indicative of a time point at which a timer interruption of said each virtual computer occurs, an accumulation of processor usage times, a time slice value, and a present time point; and
applying said virtual timer value, said accumulation of the processor usage times, said time slice value and said present time point to a processor allocation algorithm of said each virtual computer for generating an interruption due to a timer to be set by a program operating on said each virtual computer.

2. The scheduling method of the virtual computer system according to claim 1, wherein said processor allocation algorithm uses the virtual timer value of said each virtual computer to shorten a processor allocation time of another virtual computer to a nearest prospective virtual timer value for generating the interruption due to the timer.

3. The scheduling method of the virtual computer system according to claim 1, wherein said processor allocation algorithm uses the accumulation of the processor usage times of said each virtual computer to allocate the processor to a virtual computer with a minimal accumulation time in order to achieve a uniform service rate.

4. A virtual computer system having a physical computer as time-divided by a hypervisor into a plurality of virtual computers for usage, wherein
said hypervisor comprises a command simulation means for performing simulation of a privilege command issued by a virtual computer and a scheduling processing means for controlling dispatch of each virtual computer in accordance with a scheduling control table, said scheduling control table storing therein a virtual timer value for generation of a timer interruption of each virtual computer,
said command simulation means is operative, upon issuance of a timer setup command at a virtual computer, to pass control to said scheduling processing means after having updated the virtual timer value of the virtual computer in said scheduling control table, and
said scheduling processing means is operative, when a time slice period of virtual computer is expired or when the control is passed from said command simulation means, to determine a target virtual computer to be subjected to the dispatch based on the virtual timer value of said scheduling control table.

5. The virtual computer system according to claim 4, wherein said scheduling control table stores therein a present time point acquired from a present time point being held by the physical computer, and wherein
said scheduling processing means determines, when the time slice period of virtual computer is expired or when the control is passed from said command simulation means, a virtual computer having its virtual timer value equal to the present time point of said scheduling control table as the target one to be dispatched.

6. The virtual computer system according to claim 5, wherein said scheduling control table stores therein an accumulation time of processor usage times of each virtual computer, and wherein
said scheduling processing means determines, when the time slice period of virtual computer is expired or when the control is passed from said command simulation means, a virtual computer having the least accumulation time as the target one to be dispatched in a case where there is no virtual computer having its virtual timer value equal to the present time point of said scheduling control table.

7. The virtual computer system according to claim 6, wherein said scheduling control table stores therein a time slice value of virtual computer and wherein a smaller one of said time slice value and a time from the present time point to a timer interruption time point to be occurred in the nearest future is used as the dispatch time.
